(19) United States
(12) Patent Application Publication
(10) Pub. No.: US 2010/0096958 A1
(43) Pub. Date: Apr. 22, 2010

(54) Handle Latch

(75) Inventor: Richard A. Abram, Western Australia (AU)

Correspondence Address: NIXON & VANDERHYE, PC, 901 NORTH GLEBE ROAD, 11TH FLOOR, ARLINGTON, VA, 22203, US

(73) Assignee: TEMPUS COMPUTERS LIMITED, Birmingham (GB)

(21) Appl. No.: 12/531,168

(22) PCT Filed: Mar. 14, 2008
(86) PCT No.: PCT/GB2008/000913

§ 371 Date: Sep. 14, 2009

(30) Foreign Application Priority Data
Mar. 14, 2007 (GB) 0704896.0

(51) Int. Cl. A47B 81/06; A47B 96/00; B60R 11/02; E05C 1/08

(52) U.S. Cl. 312/7.2; 312/237; 292/2; 292/137

(57) ABSTRACT

An appliance with a main body portion and a pivot that allows the appliance to be pivotally mounted to a support structure so that it may be in a retracted position or a non-retracted position; said appliance having a handle portion with a first bolt recess located within said handle; and further comprising a lock body that in use is also attached to said support structure and that houses a first bolt that operably engages a first channel within said lock body; means of moving said bolt from a first position in which it is retracted within said body to a second extended position where it may engage said bolt recess and thereby lock the appliance in a retracted position against said support structure.

The present invention relates to an appliance having a handle latch. In particular, the invention relates to an appliance where the handle forms part of the latch itself.

In a preferred embodiment, the invention relates to a handle latch for use with a retractable display screen allowing the screen to be locked in a retracted position; for example, flush to the inner surface of a vehicle roof.

When mounting a display screen; for example, a LCD screen pivotally to a support structure it is desirable to have means for safely stowing the screen when not in use. Thus, if the display screen is mounted to the roof of a vehicle it is convenient to be able to retract the screen when not in use so that it is flush with the inner ceiling of the roof of the vehicle. In motor vehicles it is particularly desirable that any latch mechanism for locking such a system in a retracted position should be easily engaged and disengaged.

An aim of the present invention is to provide an appliance that can be easily operated and engaged with little difficulty. A further aim is to provide a latch that is robust and will resist impact in the event that the vehicle is involved in a collision or the like.

In one aspect the invention comprises an appliance with a main body portion and a pivot that allows the appliance to be pivotally mounted to a support structure so that it may be in a retracted position or a non-retracted position; said appliance having a handle portion with a first bolt recess located within said handle; and further comprising a lock body that in use is also attached to said support structure and that houses a first bolt that operably engages a first channel within said lock body; means of moving said bolt from a first position in which it is retracted within said body to a second position in which it is extended and where it may engage said first bolt recess and thereby lock the appliance in a retracted position against said support structure.

Preferably, the lock body houses a second bolt that operably engages a second channel within said lock body arranged so that in use the first bolt and the second bolt extend and retract in opposite directions; and wherein the second bolt in use may engage a second bolt recess located within said handle. This provides a more positive locking mechanism with increased strength and enables the restraining force required to hold the appliance closed to be equally distributed between the two lock bolts.

Preferably, the main body portion and the handle portion define an aperture within which aperture at least one bolt recess is located in a side wall of that part of the handle that defines part of said aperture. The resulting integrated handle and lock mechanism is in use more easily opened and subsequently held in order to adjust the degree of extension.

Preferably, the means of moving said at least one lock bolt comprises sliding means. Preferably, the bolt is biased in the second extended position and is hand operated by means of a handle attached to the bolt. Each bolt preferably has a handle with a spherically shaped knob; wherein to open the latch a user pulls these knobs towards one another. This arrangement allows the latch to be opened very easily by merely drawing the two knobs together by hand and also results in the user's hand being located proximal of a handle for subsequent opening of the appliance.

The appliance may house a display screen, such as a LCD screen. Preferably, the pivot is multi directional allowing independent pivoting in two planes. This allows the position of such a display screen to be readily adjusted.

The appliance is particularly suitable for use within a vehicle; for example, for attachment to the dashboard or in a roof of a vehicle.

The invention will now be described by reference to the following diagrammatic figures in which:

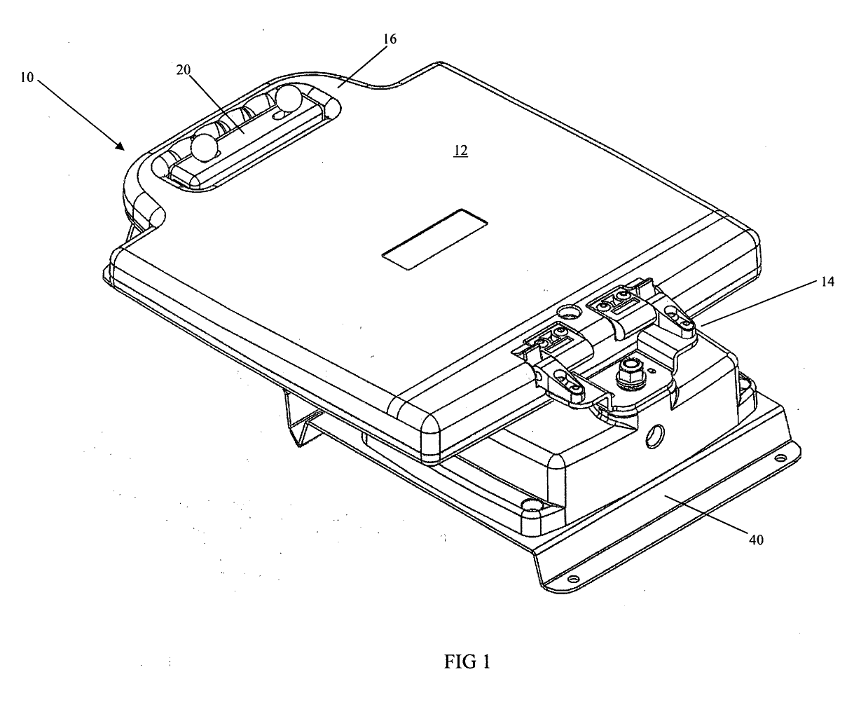

FIG. 1 shows a perspective view of a preferred embodiment of the invention; where in the appliance has a retractable display screen and is shown in a retracted position;

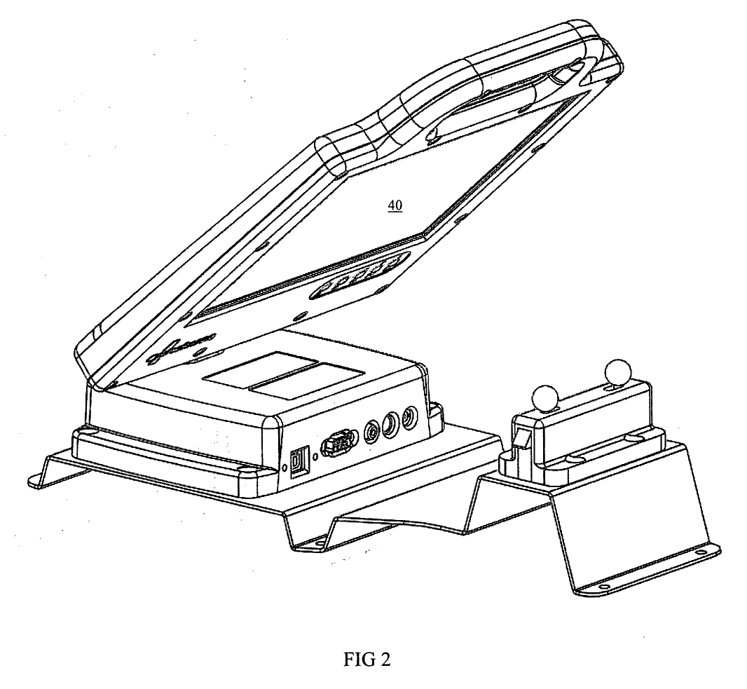

FIG. 2 is a perspective view of the appliance of FIG. 1 but in an open tilted position;

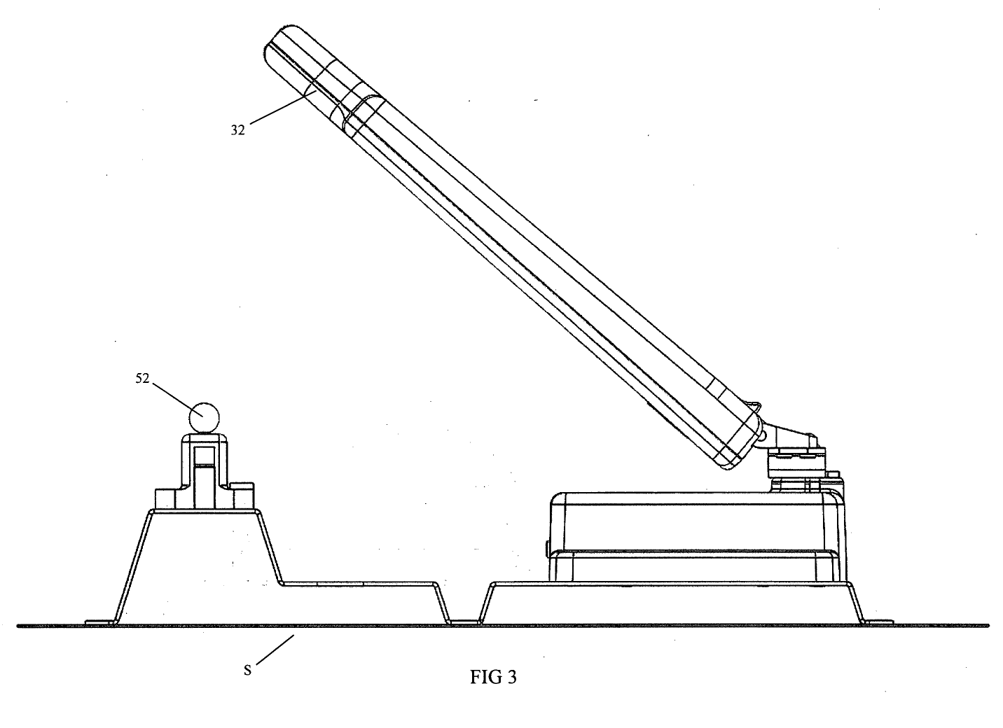

FIG. 3 shows a side elevation of the appliance;

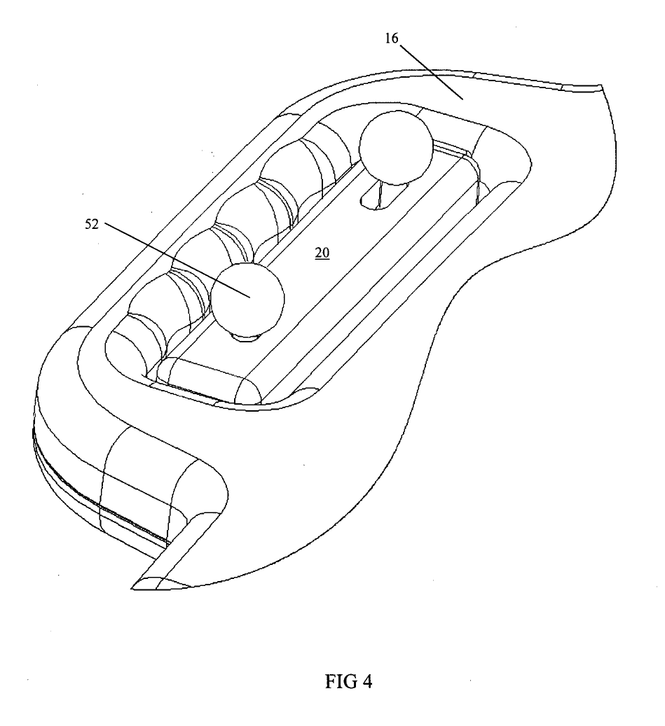

FIG. 4 shows a view of the handle portion of the appliance when the lock is engaged;

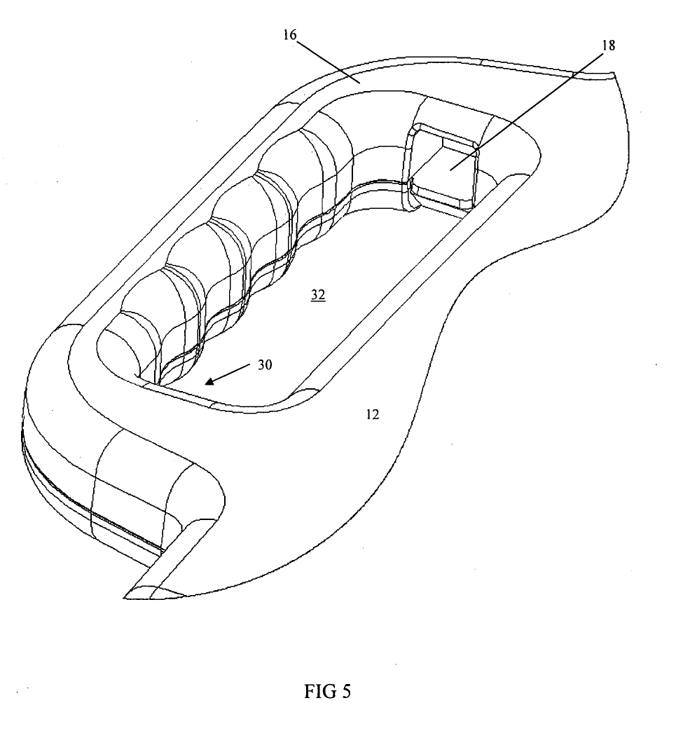

FIG. 5 shows a perspective view of the handle portion of the appliance when the lock is open;

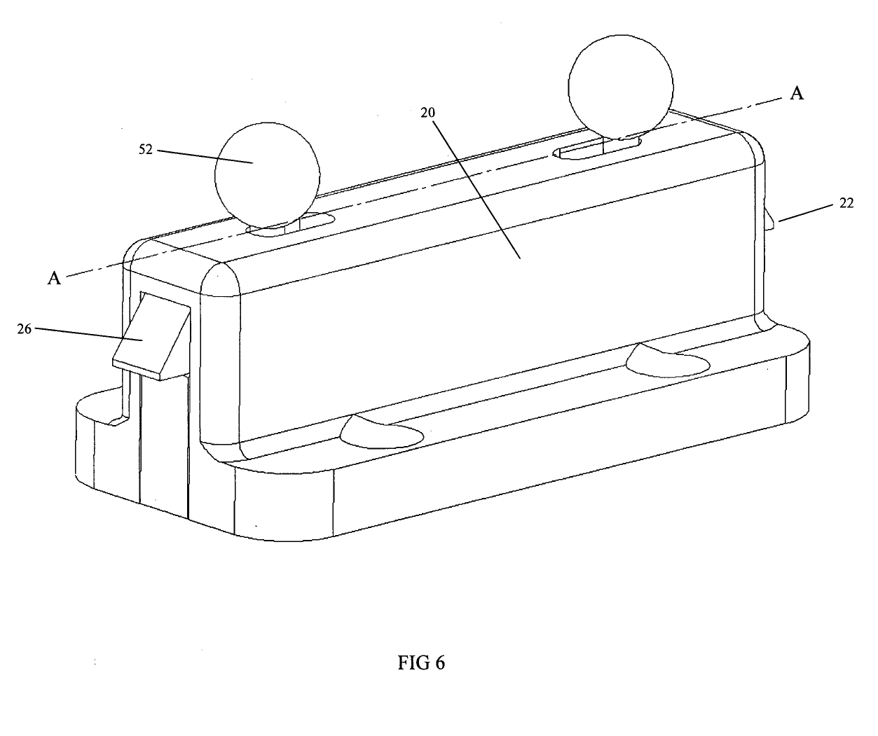

FIG. 6 shows a perspective view of the lock body; and

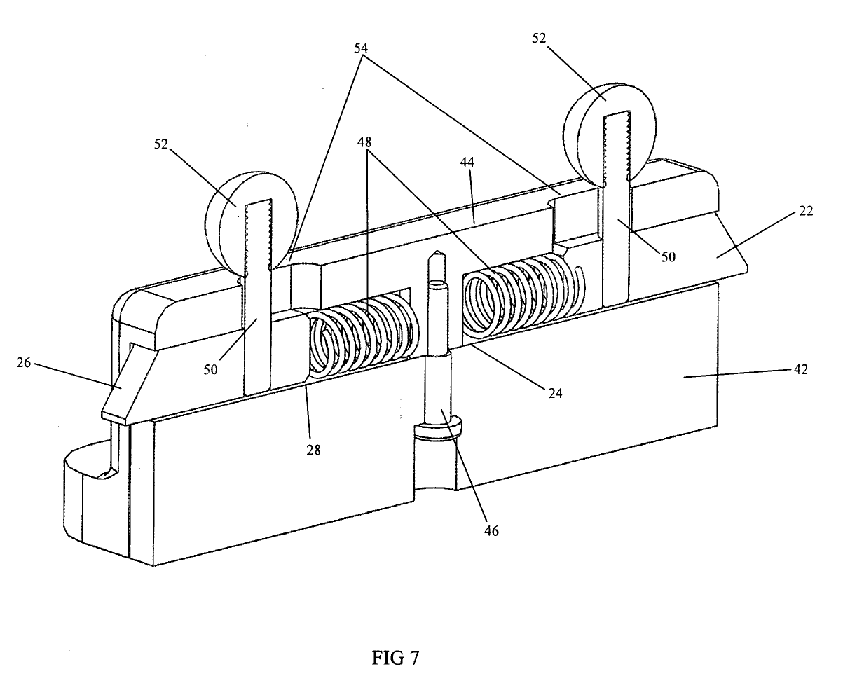

FIG. 7 shows a cutaway section of view along line A-A′ of FIG. 6.

A preferred embodiment of the invention will now be described by reference to FIGS. 1-7. These figures relate to an embodiment where the appliance houses a display screen and provides a mount for such a screen particularly suited for use in a vehicle and with the provision for stowing the screen in use.

The appliance 10 comprises a main body portion 12 that is mounted by a pivot 14 to a base member 40. In use, base member 40 is attached to a support structure such as the inner surface (S) of a vehicle or roof. The appliance 10 has a handle portion 16 that is connected to the main body portion 12. Preferably handle portion 16 is integrally formed with the main body portion 12.

In use, the main body portion 12, which in this case houses a LCD screen 40 may be tilted so that the screen is in exactly the position required by a user (see FIG. 2). FIG. 3 shows the appliance in a partly closed position and attached to a support structure (S). FIG. 4 shows the handle portion of the appliance surrounding the lock body when the appliance is in the closed and the locked position.

FIGS. 6 and 7 show details of the lock body 20 and in particular the features of the bolt mechanism. The main lock body 20 comprises a lower portion 42 and an upper portion 44 in use held together by bolt 46 and configured so as to provide a pair of channels 24 and 28 which house the first bolt 22 and a second bolt 26 respectively. Bolts 22 and 26 may be moved from a first position in which they are retracted within the lock body 20, to a second extended position where they engage recesses provided in the handle portion 16 (see later). Bolts 22 and 26 are biased in an outward (extended) position by means of resilient members 48. These resilient members preferably comprise helical springs. Means are provided (50, 52) for moving the first and second the bolts from the retracted position to the extended position. Preferably, these means comprise a knob 50 and a post 52; post 52 being connected to the rear inside portion of the bolt members. Preferably, the knobs 50 are generally spherical in shape. In use, post 50 abuts against one end wall of an aperture 54 and this limits the extent to which the bolt moves in its extended position. Aperture 54 is somewhat elongate so that a user made by gripping the pair of knobs 50 and drawing them together retract both bolts 22 and 26 simultaneously, thereby releasing the lock. The pivot mechanism of the appliance 14 is preferably provided with a further biasing mechanism (for example, a spring) so that following disengagement of the bolts as explained above, the spring pushes main body portion 12 a few degrees further open thereby assisting the user to immediately grip the handle which following unlocking of the mechanism already in a convenient position. In order to fully open the appliance the user now merely draws the handle 16 of the lid in an appropriate direction.

FIG. 5 shows that the handle 16 in combination with main body portion 12 provides an aperture 32 and within the side walls of the handle portion of this aperture there are located a first bolt recess 18 and a second bolt recess 30. In use, the first bolt 22 and the second bolt 26 engage recesses 18 and 30 respectively during closure of the appliance.

The handle or lock of the present invention may be used in a variety of applications; for example, in suitcases, briefcases and indeed any case for an appliance that has hinged components.

A variant of the appliance includes a tilt switch of any suitable kind (not shown) that is able to differentiate between the appliance being in a retracted stowed position (i.e. substantially aligned with the vehicle roof) and an open tilted position. An output from the tilt switch may be utilised for any one of a number of functions. For example, the output could be used to automatically switch off the display screen (and possibly cause a computer associated with the screen to enter a standby/suspend or other power saving mode) when stowed so as to save energy. Alternatively, the output could be used in conjunction with other vehicle sensors (such as a gear selector sensor or vehicle speed sensor) to switch off the display screen whilst the vehicle is in gear or in motion, or trigger a warning sound or visual indication.

1. An appliance with a main body portion and a pivot that allows the appliance to be pivotally mounted to a support structure so that it may be in a retracted position or a non-retracted position; said appliance having a handle portion with a first bolt recess located within said handle; and further comprising a lock body that in use is also attached to said support structure and that houses a first bolt that operably engages a first channel within said lock body; means of moving said bolt from a first position in which it is retracted within said body to a second extended position where it may engage said bolt recess and thereby lock the appliance in a retracted position against said support structure.

2. An appliance according to claim 1 wherein the lock body houses a second bolt that operably engages a second channel within said lock body.

3. An appliance according to claim 2 wherein the first bolt and the second bolt are arranged so that in use the first bolt and the second bolt extend and retract in opposite directions and wherein the second bolt in use may engage a second bolt recess located within said handle.

4. An appliance according to claim 1 wherein the main body portion and the handle portion define an aperture and wherein at least one recess is located in a side wall of that part of the handle that defines part of said aperture.

5. An appliance according to claim 1 wherein the means of moving said at least one bolt comprises at least one sliding bolt.

6. An appliance according to claim 5 wherein said bolt is biased in the second extended position and is hand operated by means of a handle attached to the bolt.

7. An appliance according to claim 2 wherein each bolt has a handle configured such that to open the latch a user pulls these knobs towards one another.

8. An appliance according to any claim 1 wherein the pivot is multi directional allowing independent pivoting two planes.

9. An appliance according to claim 1 wherein the appliance houses a display screen.

10. An appliance according to claim 1 wherein the appliance configured to be supported by the inner roof portion of a vehicle.
